(19) United States
(12) Patent Application Publication
(10) Pub. No.: US 2014/0056445 A1
(43) Pub. Date: Feb. 27, 2014

(54) Micro-electroacoustic Device

(71) Applicants: Lin-Zhen Li, Shenzhen (CN); Xiong Zhang, Shenzhen (CN)

(72) Inventors: Lin-Zhen Li, Shenzhen (CN); Xiong Zhang, Shenzhen (CN)

(73) Assignees: AAC MICROTECH (CHANGZHOU) CO., LTD., Changzhou (CN); AAC ACOUSTIC TECHNOLOGIES (SHENZHEN) CO., LTD., Shenzhen (CN)

(21) Appl. No.: 14/010,652

(22) Filed: Aug. 27, 2013

(30) Foreign Application Priority Data
Aug. 27, 2012 (CN) 201220428058.2
Aug. 27, 2012 (CN) 201220428095.3
Aug. 27, 2012 (CN) 201220429819.6

(51) Int. Cl. H04R 1/00

(52) U.S. Cl. CPC H04R 1/00
USPC 381/152; 381/162

(57) ABSTRACT

A micro-electroacoustic device includes a vibrating unit and a magnetic circuit unit supporting the diaphragm. The vibrating has a diaphragm and a voice coil driving the diaphragm to vibrate along a vibration direction. The magnetic circuit unit has a base board, a first magnetic conduction member disposed on the base board, a second magnetic conduction member disposed on the base board and around the first magnetic conduction member, and a magnetic gap formed by the first and second magnetic conduction members. The base board having an air-leaking hole communicating outside with the magnetic gap for balancing the air pressure below the diaphragm during the vibration of the diaphragm. A projection of the diaphragm along the vibration direction on the base board being within an outline of the magnetic circuit.

### FIELD OF THE INVENTION

The present invention relates to the art of micro-electroacoustic devices, particularly to a micro-electroacoustic device used in an electronic device.

### DESCRIPTION OF RELATED ART

Micro-electroacoustic devices have been widely used in portable electronic devices, such as cellular phones, notebooks, and so on. With the continuing development of the portable electronic devices, people request for more and more functions with audible sensations, which brings a rapid development of the technologies of micro-electroacoustic devices.

A related micro-electroacoustic device includes a frame, a vibrating unit and a magnetic circuit unit attached to the frame. The vibrating unit includes a diaphragm attached to the frame. The magnetic circuit unit includes a yoke positioned to the frame and a magnet disposed in the yoke.

The frame is used to accommodate the magnetic circuit unit and support the diaphragm. However, the frame of the related micro-electroacoustic device takes a lot of space, which makes the magnetic circuit unit has a small size and the micro-electroacoustic device have a low sensitivity. Further, the related micro-electroacoustic device can not provide an air-leaking configuration to balance air pressure below the diaphragm during the vibration of the diaphragm.

Therefore, it is desirable to provide a micro-electroacoustic device which can overcome the above-mentioned problems.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a micro-electroacoustic device in accordance with a first embodiment of the present invention.

FIG. 2 is an exploded view of the micro-electroacoustic device of FIG. 1.

FIG. 3 is a cross-sectional view of the micro-electroacoustic device taken along line I-I of FIG. 1.

FIG. 4 is an isometric view of a micro-electroacoustic device in accordance with a second embodiment of the present invention.

FIG. 5 is an exploded view of the micro-electroacoustic device of FIG. 4.

FIG. 6 is a cross-sectional view of the micro-electroacoustic device taken along line II-II of FIG. 4.

FIG. 7 is an isometric view of a micro-electroacoustic device in accordance with a third embodiment of the present invention.

FIG. 8 is an exploded view of the micro-electroacoustic device of FIG. 7.

FIG. 9 is a cross-sectional view of the micro-electroacoustic device taken along line III-III of FIG. 7.

### DETAILED DESCRIPTION OF THE EMBODIMENTS

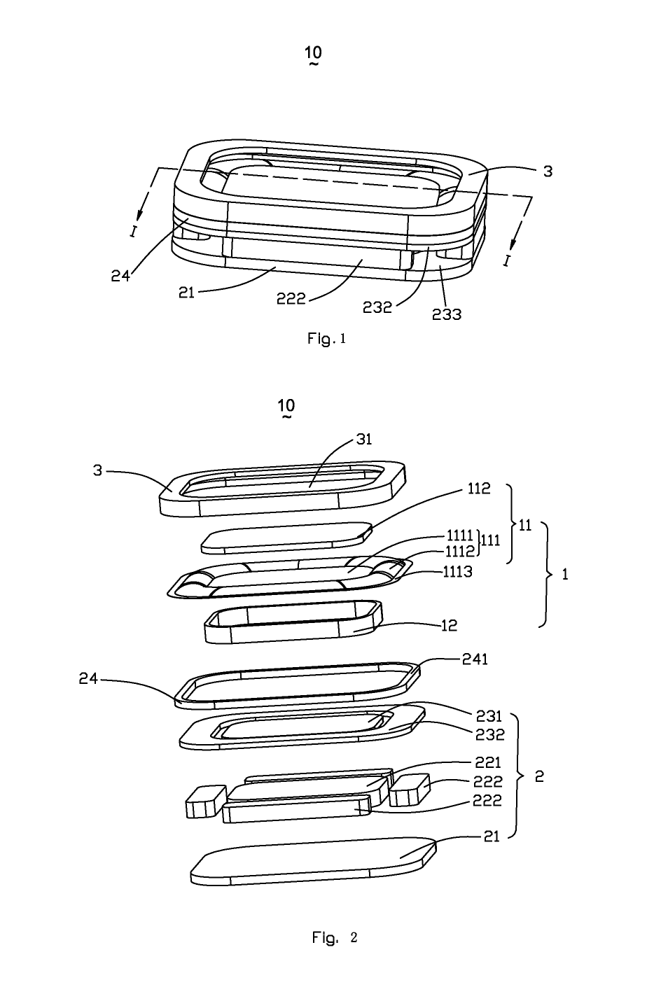

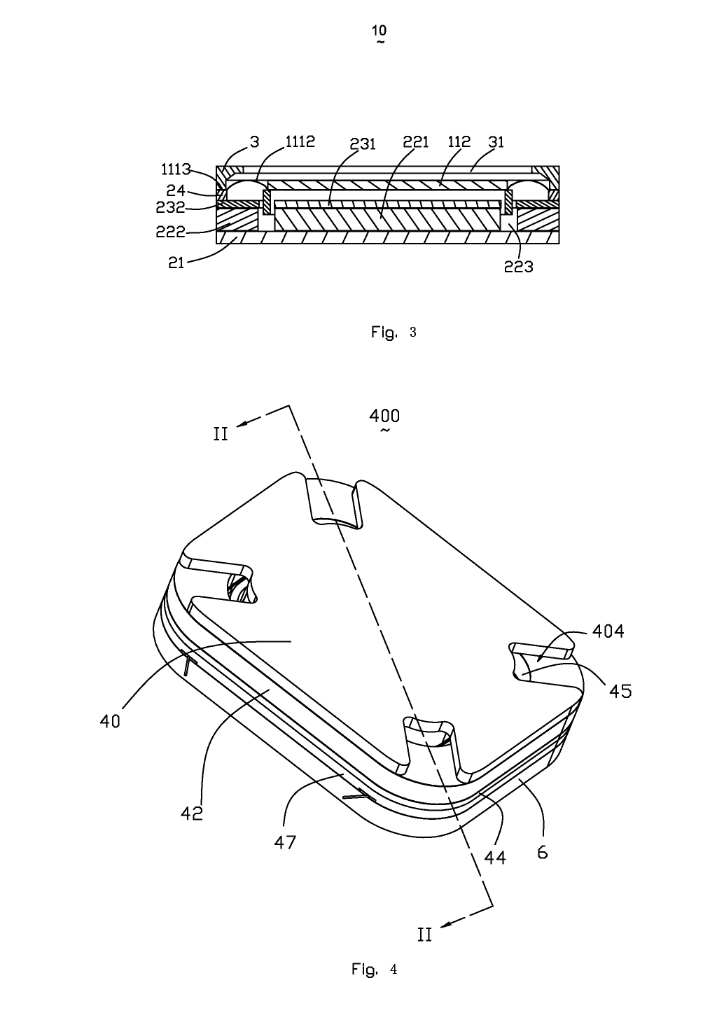

Referring to FIGS. 1-3, a micro-electroacoustic device 10 in accordance with a first embodiment of the present invention, comprises a vibration unit 1 and a magnetic circuit unit 2. The vibration unit 1 comprises a diaphragm 11 and a voice coil 12 connected with the diaphragm 11 for driving the diaphragm 11 to vibrate. Optionally, the voice coil 12 may be connected to the diaphragm 11 via a medium which is directly connected with the diaphragm 11. In other words, the voice coil 12 may be connected to the diaphragm 11 directly or indirectly. Therefore, the term “connect” here means to connect something to another via a medium or to connect something to another directly without any medium. The diaphragm 11 comprises a vibrating portion 111, a fixing portion 1113 connected with the vibrating portion 111 and a top plate 112 attached on the vibrating portion 111. The vibrating portion 111 includes a flat central portion 1111 and a curved portion 1112 extending from the central portion 1111 and around the top plate 112. The fixing portion 1113 is disposed on an edge of the vibrating portion 111. In other embodiment, the flat central portion or the top plate of the diaphragm could be omitted.

The magnetic circuit unit 2 comprises a base board 21, a first magnetic conduction member 221 disposed on a center portion of the base board 21, a second magnetic conduction member 222 disposed on a periphery portion of the base board 21 for forming a magnetic gap 223 together with the first magnetic conduction member 221. In this embodiment, four separated second magnetic conduction members 222 are provided to surround the first magnetic conduction member 221. Each two adjacent second magnetic conduction members 222 form air-leaking holes 233 therebetween. Air below the diaphragm enters the air-leaking holes 233 and finally leaks outside via the air-leaking holes 233, which balances the air pressure below the diaphragm. In other embodiment, the amount of the second magnetic conduction members 222 is variable corresponding to actual requirements. The voice coil 12 has one end accommodated in the magnetic gap 223 and the other end connected with the diaphragm 11.

The base board 21 is made of magnetic conduction materials for effectively conducting magnetic fluxes. At least one of the first and second magnetic conduction members 221, 222 is a permanent magnet. In this embodiment, both the first magnetic conduction member 221 and the second magnetic conduction members 222 are permanent magnets. In an alternative embodiment, the first magnetic conduction member is a permanent magnet and the second magnetic conduction member is made of magnetic conduction materials for effectively conducting magnetic fluxes. Furthermore, the second magnetic conduction member and the base board are formed an integral unit. On the contrary, the first magnetic conduction member is made of magnetic conduction materials for effectively conducting magnetic fluxes and the second magnetic conduction member is a permanent magnet. The first magnetic conduction member and the base board are formed an integral unit.

The magnetic circuit unit 2 is a necessary component or combination of a plurality of components used in an electro-acoustic device. The magnetic circuit unit 2 is used to provide a closed loop of magnetic fluxes, and is formed by magnetic conduction materials. In this embodiment, the magnetic circuit unit 2 further comprises a first pole plate 231 attached on a top face of the first magnetic conduction member 221 and a ring-shaped second pole plate 232 attached on top faces of the second magnetic conduction members 222. The second pole plate 232 has a top face higher than that of the first pole plate 231 thereby providing a greater vibration space to the diaphragm 11. In fact, this embodiment provides a solution that the diaphragm 11 connects to the magnetic circuit unit 2. While electrified, the voice coil 12 drives the diaphragm 11 to vibrate along a vibration direction by the interaction between the voice coil 12 and the magnetic circuit unit 2. Generally, the vibration direction is perpendicular to the base board 21. In this embodiment, the diaphragm 11 could be connected to the second pole plate 232. And, for enlarging the vibration space of the diaphragm, a top face of the second pole plate 232 is optionally higher than that of the first pole plate 231. In an alternative embodiment, the second pole plate is an optional element, and without the second pole plate, the diaphragm could be positioned on the second magnetic conduction members directly.

A gasket 24 is attached on the second pole plate 232. The vibrating unit 1 is mounted to the magnetic circuit unit 2 with the fixing portion 1113 of the diaphragm 11 positioned on the gasket 24. The gasket 24 has a mounting surface 241 for fixing the fixing portion 1113 of the diaphragm 11. The mounting surface 241 is higher than the first pole plate 232, so that a greater vibration space is formed for the diaphragm 11. In an alternative embodiment, the gasket can be omitted. The vibrating unit is directly mounted on the magnetic circuit unit. In fact, the gasket 24 is an optional element for increasing the vibration space of the diaphragm 11. It is also feasible that the diaphragm 11 is directly connected to the magnetic circuit unit 2 without the gasket 24. Again, the term “connect” here means to connect something to another via a medium or to connect something to another directly without any medium.

The curved portion 1112 of the diaphragm 11 is disposed above the second pole plate 232. A projection of the diaphragm 11 on the base board 21 along the vibration direction of the diaphragm is within an outline of the base board 21. Compared with the related art, the diaphragm 11 is supported by the magnetic circuit unit 2, and the voice coil 12 is accommodated in a space formed by the diaphragm and the magnetic circuit unit, which configuration omits the frame used in related art. In addition, if provided with a same size to the related art, the magnetic circuit unit could be enlarged for providing improved performance.

Optionally, the micro-electroacoustic device 10 further includes a front cover 3 attached to the vibrating unit 1 and the magnetic circuit unit 2.

The front cover 3 has an acoustic hole 31 for emitting sounds generated by the diaphragm 11. In addition, the front cover 3 presses on the fixing portion 1113 of the diaphragm 11 for fixing the diaphragm 11 on the magnetic circuit unit 2.

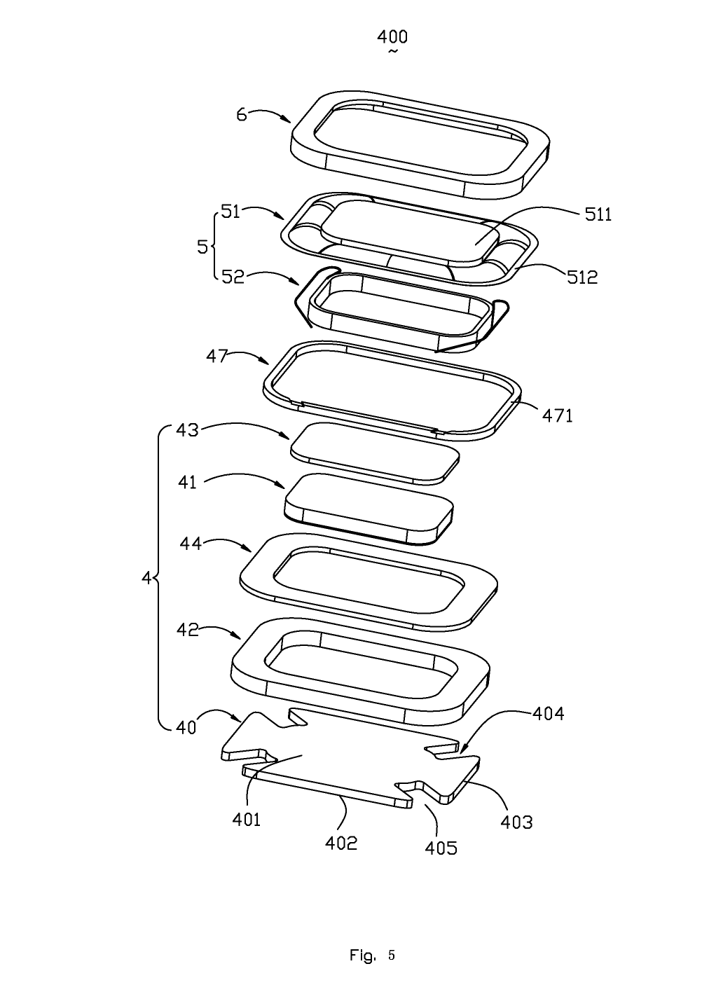

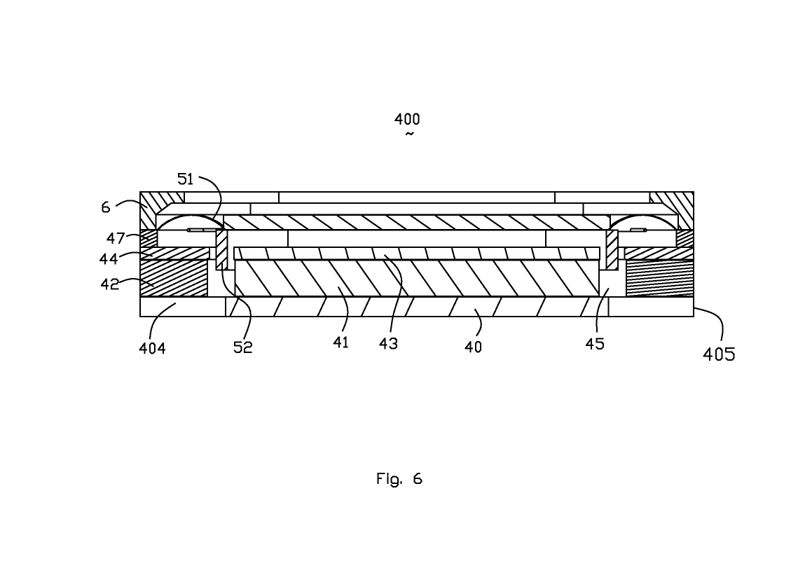

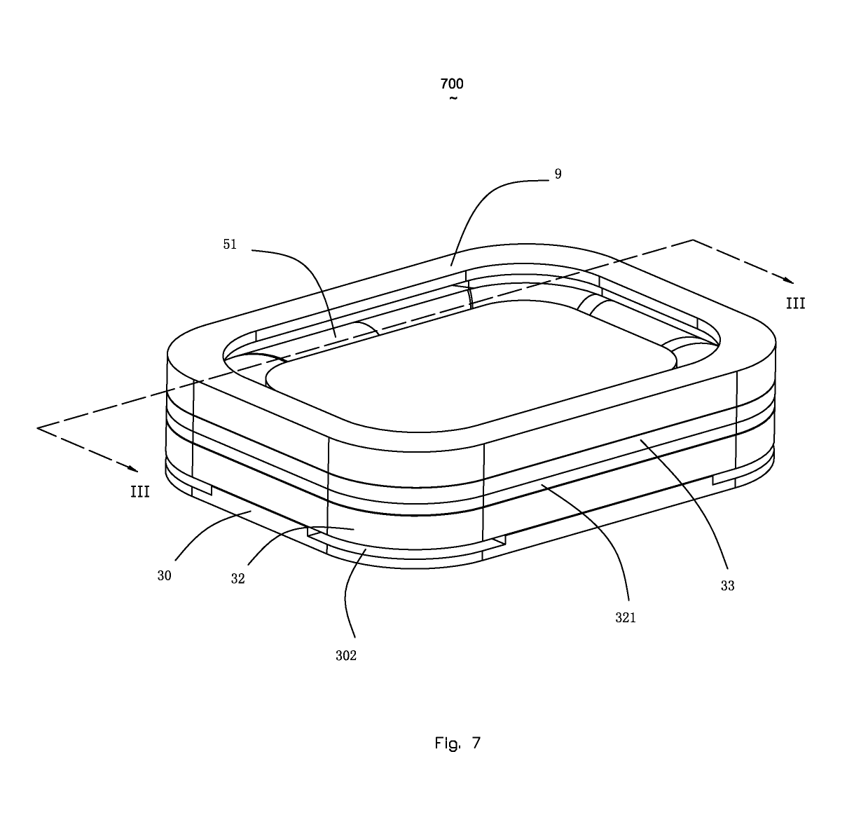

Referring to FIGS. 4-6, comparing with the first embodiment, a micro-electroacoustic device in accordance with a second embodiment of the present invention has a second magnetic conduction member having an integrated ring-shaped configuration without gaps.

The micro-electroacoustic device 400 has a magnetic circuit unit 4, a gasket 47 mounted on the magnetic circuit unit 4 and a vibrating unit 5 mounted on the gasket 47. The vibrating unit 5 has a diaphragm 51 and a voice coil 52 connected with the diaphragm 51. The diaphragm 51 has a vibrating portion 511 and a fixing portion 512 connecting the vibrating portion 511. The magnetic circuit unit 4 has a base board 40, a first magnetic conduction member 41 mounted on the base board 40, a ring-shaped second magnetic conduction member 42 mounted on the base board 40 and surrounding the first magnetic conduction member 41, a first pole plate 43 attached on a top face of the first magnetic conduction member 41, a second pole plate 44 attached on a top face of the second magnetic conduction member 42 for fixing the gasket 27 directly, and a magnetic gap 45 formed by an outer surface of the first magnetic conduction member 41 and a first pole plate 43 and an inner surface of the second magnetic conduction member 42 and the second pole plate 44. When assembled, the fixing portion 512 of the vibrating unit 5 is mounted on the gasket 47, so that a vibrating space is formed for the diaphragm 51. The gasket 47 has a mounting surface 471 higher than the first pole plate 43 for providing a greater vibration space to the diaphragm 51. The second magnetic conduction member 42 may be a ring surrounding the first magnetic conduction member 41, or may be a plurality of separated pieces arranged around the first magnetic conduction member 41. The magnetic circuit unit 4 is used to provide the magnetic gap 45 and to support the gasket 47 and the diaphragm 51, no matter how the first or second magnetic conduction member 41, 42 is configured. The second magnetic conduction member 42 may be a ring surrounding the first magnetic conduction member 41, or may be a plurality of separated pieces arranged around the first magnetic conduction member 41. In fact, the shape of the second magnetic conduction member is not restricted to the ring as described in this embodiment. Alternatively, the second magnetic conduction member may be a rectangular plate.

The base board 40 is made of magnetic conduction materials for effectively conducting magnetic fluxes and has an upper surface 401 for supporting the first and second magnetic conduction members 41, 42, a lower surface 402 opposite to the upper surface 401, and a sidewall 403 connecting the upper and the lower surfaces 401, 402. At least one air-leaking hole 404 is formed complete through the upper and lower surfaces 401, 402, and is communicated with the magnetic gap 45 for balancing the air pressure in the magnetic gap 45 and the outside, by which the performance of the micro-electroacoustic device is improved. In an alternative embodiment, the air-leaking hole 404 further has a side opening 405 in the sidewall 403 of the base board 40, so air below the diaphragm 51 is leaked from along a side direction perpendicular to the vibration direction and a bottom direction of the micro-electroacoustic device. The bottom direction is designed parallel to the vibration direction and along a direction away from the diaphragm.

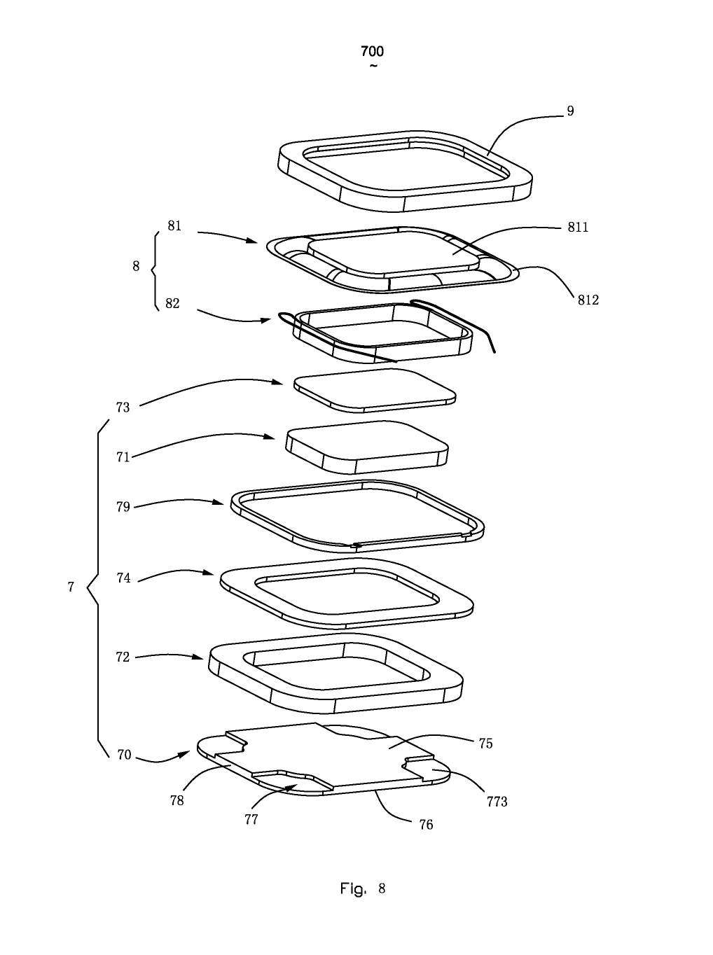

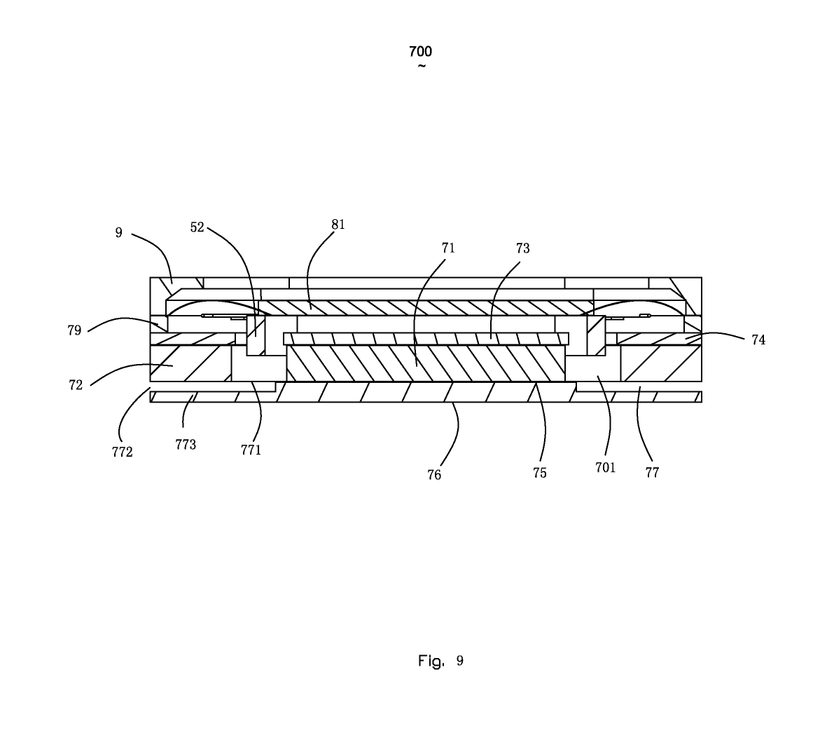

Referring to FIGS. 7 to 9, a micro-electroacoustic device 700 in accordance with a third embodiment of the present invention, in which the micro-electroacoustic device 700 has a magnetic circuit unit 7, a gasket 79 directly mounted on the magnetic circuit unit 7, a vibrating unit 8 directly mounted on the gasket 79 and a front cover 9 attached to the vibrating unit 8. The vibrating unit 7 has a diaphragm 81 and a voice coil 82 connected with the diaphragm 82. The diaphragm 81 has a vibrating portion 811 and a fixing portion 812 connecting the vibrating portion 811. The magnetic circuit unit 7 has a base board 70, a first magnetic conduction member 71 mounted on the base board 70, a ring-shaped second magnetic conduction member 72 mounted on the base board 70 and surrounding the first magnetic conduction member 71, a first pole plate 73 attached on a top face of the first magnetic conduction member 71, a second pole plate 74 attached on a top face of the second magnetic conduction member 72 for fixing the gasket 79 directly, and a magnetic gap 701 formed by an outer surface of the first magnetic conduction member 71 and a first pole plate 73 and an inner surface of the second magnetic conduction member 72 and the second pole plate 74. The gasket 79 has a mounting surface 791 near the diaphragm 81 than the second pole plate 74. When assembled, the fixing portion 812 of the vibrating unit 8 is directly mounted on the gasket 79, so that a vibrating space is formed for the diaphragm 81.

The base board 70 is made of magnetic conduction materials for effectively conducting magnetic fluxes and has an upper surface 75 for supporting the first and second magnetic conduction members 71, 72, a lower surface 76 opposite to the upper surface 75, and a sidewall 78 connecting the upper and lower surfaces 75, 76. At least an air-leaking hole 77 is formed complete through the upper surface 75 and is communicated with the magnetic gap 701 for balancing the air pressure in the magnetic gap 701 and the outside. The air-leaking hole 77 has an upper opening 771 in the upper surface 65, and a side opening 772 in the sidewall 78. The upper opening 672 is partially overlapped by the magnetic gap 701 for communicating the magnetic gap 701 with the side opening 772 to balance air pressure below the diaphragm 71 during the vibration of the diaphragm 71. In this embodiment, air below the diaphragm is leaked along the side direction perpendicular to the vibration direction. The air-leaking hole 77 further has a bottom 773 positioned in the air-leaking hole 701 and connected with the lower surface 76 for reducing the magnetic leakage of the base board 70. In an alternative embodiment, the bottom is positioned between the upper and lower surface.

According to the embodiments described above, the fixing portion of diaphragm could be directly or indirectly connected to the outer pole plate with a top face of the outer pole plate higher than the inner pole plate. The fixing portion of diaphragm also could be indirectly connected to the outer pole plate via a gasket with a top face of the gasket higher than that of the inner pole plate. A greater space for vibration of the diaphragm is optional and preferable. A projection of the diaphragm along the vibration direction on the base board is not larger than the base board, by which the micro-electroacoustic device is provided with smaller size, or is provided with enlarged magnetic circuit unit. Sound quality of the micro-electroacoustic device having such a configuration is accordingly improved.

The embodiments described above may be summarized as follows. A micro-electroacoustic device includes a magnetic circuit unit, a diaphragm connected to the magnetic circuit unit, and a voice coil connected to the diaphragm for driving the diaphragm to vibrate along a vibration direction. The magnetic circuit unit includes an inner part, an outer part, a magnetic gap formed between the inner part and the outer part and an air-leaking hole formed on the outer part and communicated the magnetic gap with the outside of the micro-electroacoustic device for balancing the air pressure in the magnetic gap and the outside. The voice coil is partially received and capable of vibrating in the magnetic gap. One of the inner part and the outer part of the magnetic circuit unit is a permanent magnet. An edge of the diaphragm is connected to the outer part of the magnetic circuit unit. By virtue of such a configuration, a projection of the diaphragm along the vibration direction on the magnetic circuit unit is located within the boundary of the magnetic circuit unit, thereby omitting a frame used in the related art for supporting the diaphragm and the magnetic circuit unit. As the frame used in the related art is omitted by this invention, an outer side of the micro-electroacoustic device is formed by the outer part of the magnetic circuit unit and the edge of the diaphragm. For enlarging a vibration space of the diaphragm, the outer part is higher than the inner part, or the diaphragm connects to the outer part via a gasket attaching to the top of the outer part.

It will be understood that the above-mentioned particular embodiments is shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A micro-electroacoustic device, comprising:
a vibrating unit having a diaphragm and a voice coil driving the diaphragm to vibrate along a vibration direction, the diaphragm having a vibrating portion and a fixing portion connecting with the vibrating portion;
a magnetic circuit unit supporting the fixing portion of the diaphragm, having a base board, a first magnetic conduction member disposed on the base board, a second magnetic conduction member disposed on the base board and around the first magnetic conduction member, and a magnetic gap formed by the first and second magnetic conduction members, the base board having an air-leaking hole communicating outside of the micro-electroacoustic device with the magnetic gap for balancing the air pressure below the diaphragm during the vibration of the diaphragm; and
a projection of the diaphragm along the vibration direction on the base board being within an outline of the magnetic circuit.

2. The micro-electroacoustic device as claimed in claim 1, wherein the base board further has a upper surface for supporting the first and second magnetic conduction members, a lower surface opposite to the upper surface, and a sidewall connecting the upper and lower surfaces and the air-leaking hole is formed complete through the upper and lower surfaces.

3. The micro-electroacoustic device as claimed in claim 2, wherein the air-leaking hole further has a side opening in the sidewall.

4. The micro-electroacoustic device as claimed in claim 1, wherein the base board further has a upper surface for supporting the first and second magnetic conduction members, a lower surface opposite to the upper surface, and a sidewall connecting the upper and lower surfaces, and the air-leaking hole is formed complete through the upper surface and the sidewall.

5. The micro-electroacoustic device as claimed in claim 4, wherein the air-leaking hole further has a bottom positioned between the upper and lower surface.

6. The micro-electroacoustic device as claimed in claim 4, wherein the air-leaking hole further has a bottom positioned in the air-leaking hole and connected with the lower surface.

7. The micro-electroacoustic device as claimed in claim 1, wherein the magnetic circuit unit includes a first pole plate attached on the first magnetic conduction member and a second pole plate attached on the second magnetic conduction member.

8. The micro-electroacoustic device as claimed in claim 7, wherein the fixing portion of the diaphragm is directly positioned on the second pole plate.

9. The micro-electroacoustic device as claimed in claim 8, wherein a top face of the second pole plate is higher than that of the first pole plate.

10. The micro-electroacoustic device as claimed in claim 7 further including a gasket disposed between the fixing portion of the diaphragm and the second pole plate.

11. The micro-electroacoustic device as claimed in claim 10, wherein a top face of the gasket is higher than that of the first pole plate.

12. A micro-electroacoustic device, comprising:
a magnetic circuit unit including an inner part, an outer part, a magnetic gap formed between the inner part and the outer part, and an air-leaking hole formed on the outer part and communicated the magnetic gap with the outside of the micro-electroacoustic device for balancing the air pressure in the magnetic gap and the outside, one of the inner part and the outer part including a permanent magnet;
a diaphragm including an edge positioning on the outer part of the magnetic circuit unit; and
a voice coil connecting the diaphragm for driving the diaphragm to vibrate along a vibration direction.

13. The micro-electroacoustic device as described in claim 12 further including a front cover pressing on the edge of the diaphragm to the outer part of the magnetic circuit unit.

14. The micro-electroacoustic device as described in claim 12 further including a gasket between the edge of the diaphragm and the outer part of the magnetic circuit unit, the gasket being higher than the inner part of the magnetic circuit unit.

15. The micro-electroacoustic device as described in claim 12, wherein the outer part is higher than the inner part.

16. The micro-electroacoustic device as described in claim 12 including an outer side formed by the outer part of the magnetic circuit unit and the edge of the diaphragm.
